(19) United States
(12) Patent Application Publication
(10) Pub. No.: US 2019/0073323 A1
(43) Pub. Date: Mar. 7, 2019

(54) BUFFERING TRANSACTION REQUESTS TO A SUBSYSTEM VIA A BUS INTERCONNECT

(71) Applicant: QUALCOMM INCORPORATED, San Diego, CA (US)

(72) Inventors: Siddesh Halavarthi Math Revana, Bangalore (IN); Kaustav Roychowdhury, Bangalore (IN)

(21) Appl. No.: 15/698,386

(22) Filed: Sep. 7, 2017

(51) Int. Cl. G06F 13/16; G06F 13/40; G06F 12/0804

(52) U.S. Cl. CPC G06F 13/1642; G06F 13/1673; G06F 9/30047; G06F 12/0804; G06F 2212/1044; G06F 13/4027

(57) ABSTRACT

Categories of transaction requests from a processor may be buffered until one or more conditions occur, rather than being immediately transferred to a bus interconnect system. Transaction request traffic between the processor and bus interconnect system may be monitored, and it may be determined whether a transaction request is of a first category rather than a second category. First-category bus transaction requests are stored in a buffer. Transaction request traffic between the bus interconnect system and one or more client components may also be monitored. It may be determined whether an aggregate amount of the transaction request traffic between the bus interconnect system and the client components is lower than a threshold. If the aggregate amount of the transaction request traffic between the bus interconnect system and the client components is lower than the threshold, buffered bus transaction requests may be transferred to the bus interconnect system.

### DESCRIPTION OF THE RELATED ART

Portable computing devices (“PCDs”) are becoming necessities for people on personal and professional levels. PCDs may include cellular telephones, portable digital assistants, portable game consoles, palmtop computers, and other portable electronic processing devices.

A PCD includes various electronic subsystems and components, such as a system-on-chip (“SoC”). An SoC may include, for example, central processing units (“CPUs”), graphics processing units (“GPUs”), and digital signal processors (“DSPs”). A PCD also includes one or more memory subsystems, such as a double data-rate dynamic random access memory (“DDR-DRAM” or “DDR”). One or more buses are commonly included in an SoC to provide communication paths among the various components. A bus bridge may interconnect multiple buses, such as a memory bus, CPU bus, etc.

Data communication bottlenecks may occur when multiple components attempt to communicate via the same bus or similar interconnect system. To maximize data throughput in an SoC, it is desirable to minimize such bottlenecks.

### SUMMARY OF THE DISCLOSURE

Methods, systems, and computer program products are disclosed for buffering bus transaction requests from a processor to a bus bridge.

In accordance with an exemplary method, bus transaction request traffic between a processor and a bus interconnect system may be monitored. A bus transaction request from the processor may be buffered, i.e., stored in a memory buffer, until a condition occurs. When such a condition occurs, buffered bus transaction requests are transferred to the bus interconnect system. An example of such a condition is that aggregate bus transaction request traffic between the bus interconnect system and one or more bus client components is lower than a threshold.

An exemplary system for buffering bus transaction requests from a processor to a bus interconnect system may include a bus interconnect system configured to interconnect a processor bus and a subsystem bus. The system may further include a buffer memory system and a buffer flush controller. The buffer memory system may be configured to buffer a bus transaction request from the processor until a condition occurs. The buffer flush controller may be configured to determine whether such a condition occurs. An example of such a condition is that aggregate bus transaction request traffic between the bus interconnect system and one or more bus client components is lower than a threshold.

An exemplary computer program product for buffering bus transaction requests in a bus interconnect system may include processor-executable logic embodied in at least one non-transitory storage medium. Execution of the logic by one or more processors may configure the bus interconnect system to monitor bus transaction request traffic between a processor and the bus interconnect system, and to buffer a bus transaction request from the processor until a condition occurs. Execution of the logic may further configure the bus interconnect system to determine whether such a condition occurs. An example of such a condition is that aggregate bus transaction request traffic between the bus interconnect system and one or more bus client components is lower than a threshold.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a block diagram of a system configured to buffer bus transaction requests from a processor, in accordance with an exemplary embodiment.

FIG. 2 is a block diagram of a system configured to buffer memory transaction requests from a CPU cluster to a bus bridge, in accordance with an exemplary embodiment.

FIG. 3 is a block diagram of a system configured to buffer memory transaction requests from a CPU cluster to a bus bridge, showing features of the buffer flush controller, in accordance with an exemplary embodiment.

FIG. 4 is a timing diagram illustrating CPU and client device memory transaction requests in the absence of buffering, in accordance with an exemplary embodiment.

FIG. 5 is a timing diagram similar to FIG. 4, illustrating the effect of buffering CPU memory transaction requests, in accordance with an exemplary embodiment.

FIG. 6A is a flow diagram illustrating a portion of a method for buffering bus transaction requests from a processor, in accordance with an exemplary embodiment.

FIG. 6B is a flow diagram similar to FIG. 6A, illustrating another portion of the method.

FIG. 7 is a block diagram of a portable computing device, in accordance with an exemplary embodiment.

### DETAILED DESCRIPTION

The word “exemplary” is used herein to mean “serving as an example, instance, or illustration.” Any aspect described herein as “exemplary” is not necessarily to be construed as preferred or advantageous over other aspects.

The term “portable computing device” (“PCD”) is used herein to describe any device operating on a limited capacity power supply, such as a battery. Although battery operated PCDs have been in use for decades, technological advances in rechargeable batteries coupled with the advent of third generation (“3G”) and fourth generation (“4G”) wireless technology have enabled numerous PCDs with multiple capabilities. Therefore, a PCD may be a cellular telephone, a satellite telephone, a pager, a personal digital assistant (“PDA”), a smartphone, a navigation device, a smartbook or reader, a media player, a combination of the aforementioned devices, or a laptop or tablet computer with a wireless connection, among others.

The terms “component,” “system,” “subsystem,” “module,” “database,” and the like are used herein to refer to a computer-related entity, either hardware, firmware, or a combination of hardware and firmware. For example, a component may be, but is not limited to being, a processor of portion thereof, a processor or portion thereof as configured by a program, process, object, thread, executable, etc. A component may be localized on one system and/or distributed between two or more systems.

The terms “application” or “application program” may be used synonymously to refer to a software entity having executable content, such as object code, scripts, byte code, markup language files, patches, etc. In addition, an “application” may further include files that are not executable in nature, such as data files, configuration files, documents, etc.

A reference herein to “DDR” memory components will be understood to encompass any of a broader class of synchronous dynamic random access memory (“SDRAM”) and will not limit the scope of the solutions disclosed herein to a specific type or generation of SDRAM. Moreover, certain embodiments of the solutions disclosed herein may be applicable to DDR, DDR-2, DDR-3, low power DDR (“LPDDR”) or any subsequent generation of SDRAM.

The terms “central processing unit” (“CPU”), “digital signal processor” (“DSP”), and “graphics processing unit” (“GPU”) are non-limiting examples of processors that may reside in a PCD. These terms are used interchangeably herein except where otherwise indicated.

In some conventional architectures (not shown), a component that arbitrates bus traffic, such as a bus bridge, may assign a higher priority to transaction requests from a CPU than to transaction requests from other components. However, not all types of CPU transaction requests are necessarily time-critical. A delay in servicing non-time-critical transaction requests is unlikely to adversely impact quality of service (“QoS”). Nevertheless, arbitrating such non-time-critical CPU transaction requests as though they were time-critical may adversely impact overall QoS in instances in which it delays other memory clients from conducting memory transactions. The exemplary embodiments described herein help minimize such bottlenecks by buffering non-time-critical CPU transaction requests to a subsystem and then releasing or transferring the buffered write requests to the subsystem during a time of low traffic among the components.

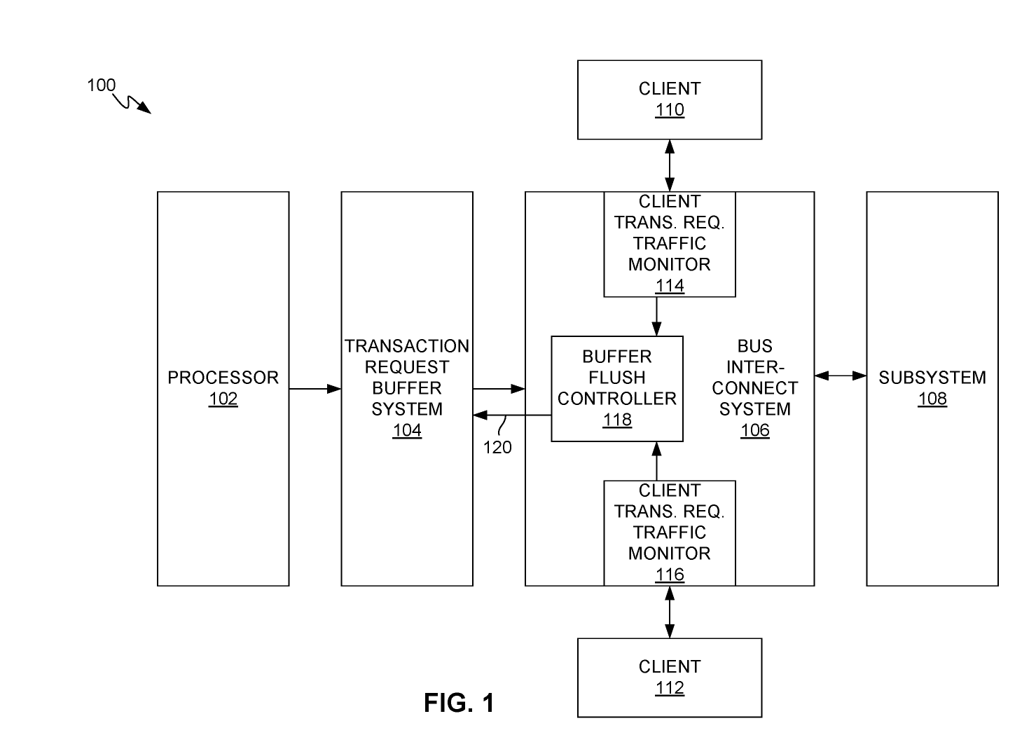

As illustrated in FIG. 1, in an illustrative or exemplary embodiment, a system 100 may include a processor 102, a transaction request buffer system 104, and a bus interconnect system 106. The term “bus interconnect system” as used in this disclosure is intended to encompass a bus interconnect system, a memory controller having a connection to a bus or bus system, and combinations thereof. System 100 may also include a subsystem 108, such as, for example, a DDR memory subsystem.

In operation, processor 102 issues bus transaction requests to subsystem 108 via bus interconnect system 106. Bus interconnect system 106 couples the various buses utilized by processor 102, subsystem 108, and client components 110 and 112. In other embodiments, such a bus interconnect system may be any type of bus, bus bridge, interconnect fabric, or other data bus interconnect system. Client components 110 and 112 may comprise any type of component that operates as a client of subsystem 108. For example, in an embodiment in which subsystem 108 is a memory subsystem, client components 110 and 112 may be memory clients, i.e., components that access the memory. Although only two client components 110 and 112 are shown for purposes of clarity, system 100 may include any number of such client components. Although processor 102 similarly accesses subsystem 108 and thus similarly operates as a client of subsystem 108, processor 102 is referred to as a “processor” for purposes of clarity.

Transaction request buffer system 104 is configured to monitor bus transaction request traffic between processor 102 and bus interconnect system 106, to determine whether a bus transaction request from processor 102 to bus interconnect system 106 is of a first category rather than a second category, and to buffer or store the bus transaction request if the bus transaction request is of the first category rather than the second category. In other words, if transaction request buffer system 104 determines that the bus transaction request is of the first category rather than the second category, it does not immediately transfer the bus transaction request to bus interconnect system 106; rather, transaction request buffer system 104 defers or withholds the transfer and stores the bus transaction request until one or more conditions occur, as described below. In other words, the first and second categories are mutually exclusive; a category of request that is buffered is not also transferred immediately to bus interconnect system 106. Requests of the second category are passed through transaction request buffer system 104 without being stored or withheld and appear directly at an input of bus interconnect system 106. In an exemplary embodiment, the first category may include non-time-critical bus transaction requests, and the second category may include time-critical bus transaction requests.

Bus interconnect system 106 may include client bus transaction request traffic monitors 114 and 116 configured to monitor bus transaction request traffic (i.e., bandwidth usage) between bus interconnect system 106 and client components 110 and 112, respectively. As well understood by one of ordinary skill in the art, “traffic” in this context refers to the amount of bandwidth occupied by transaction requests. In the exemplary embodiment, the transaction requests may include read requests and write requests. Client bus transaction request traffic monitors 114 and 116 may measure bandwidth in any manner, and may represent the measured bandwidth in any manner, such as number of bits per unit time (e.g., Mb/s). Although only two client bus transaction request traffic monitors 114 and 116 are shown for purposes of clarity, bus interconnect system 106 may include any number of such client bus transaction request traffic monitors.

In the illustrated embodiment, each of client bus transaction request traffic monitors 114 and 116 corresponds to, or is associated with, exactly one of the client components 110 and 112. Specifically, in the illustrated embodiment client bus transaction request traffic monitor 114 monitors bus transaction request traffic between client component 110 and bus interconnect system 106, while client bus transaction request traffic monitor 116 monitors bus transaction request traffic between client component 112 and bus interconnect system 106. Nevertheless, in other embodiments such client bus transaction request traffic monitors may be distributed or, conversely, integrated together, in any other manner.

Bus interconnect system 106 may further include a buffer flush controller 118 coupled to client bus transaction request traffic monitors 114 and 116. Buffer flush controller 118 may be configured to determine an aggregate amount of bus transaction request traffic between client components 110 and 112 and bus interconnect system 106. For example, buffer flush controller 118 may determine an aggregate amount by adding the amount of bus transaction request traffic between client component 110 and bus interconnect system 106 to the amount of bus transaction request traffic between client component 112 and bus interconnect system 106. Buffer flush controller 118 may be further configured to determine whether the aggregate amount of bus transaction request traffic is lower than a bandwidth threshold. The above-referenced conditions may include such a determination that the aggregate amount of bus transaction request traffic is lower than the bandwidth threshold. Buffer flush controller 118 may be configured to generate a flush signal 120 indicating such a condition. Transaction request buffer system 104 may be further configured to, in response to an assertion of flush signal 120 or other indication that such a condition has occurred, transfer buffered bus transaction requests to bus interconnect system 106.

Thus, transaction request buffer system 104 buffers or stores certain categories of bus transaction requests issued by processor 102 and withholds them from bus interconnect system 106 until such time as the aggregate amount of bus transaction request traffic may be lower than the bandwidth threshold, and only then, or upon another condition as may be described below, does the transaction request buffer system 104 transfer the buffered bus transaction requests to bus interconnect system 106. In this manner, the buffered non-time-critical bus transaction requests issued by processor 102 are handled during slack periods of usage of bus interconnect system 106 by client components 110 and 112. The foregoing allows for more efficient use of the bus or interconnect, as bus transaction requests issued by client components 110 and 112 may be less frequently delayed in favor of bus transaction requests issued by processor 102.

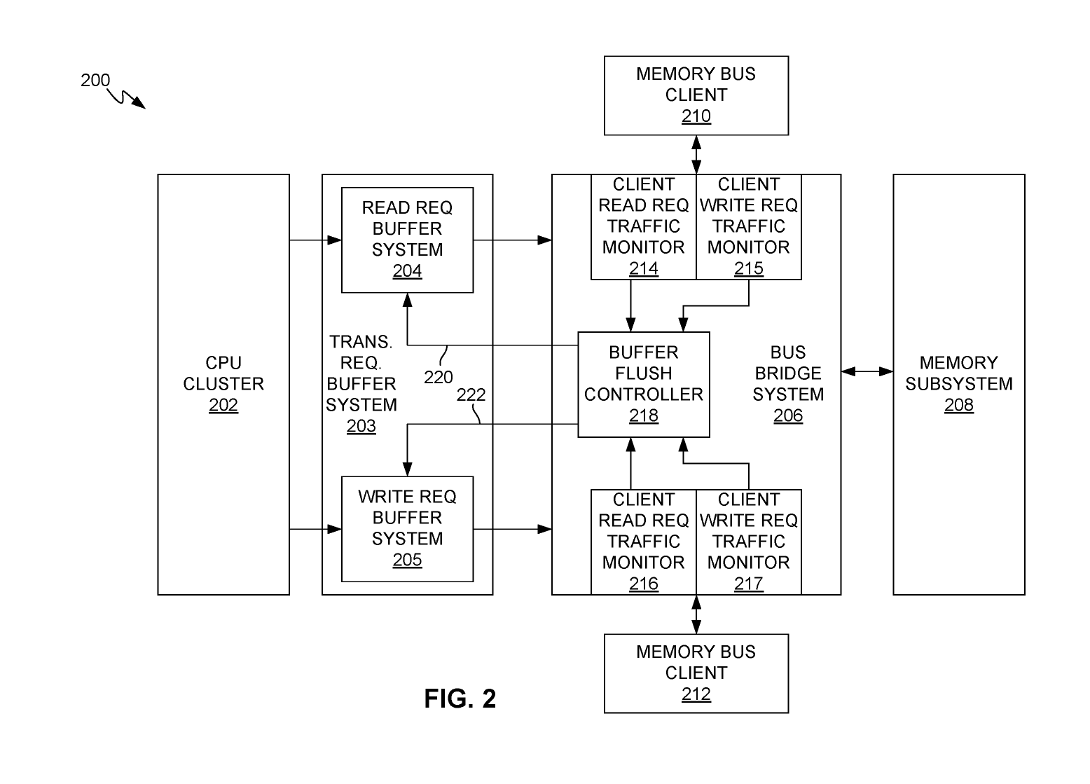

As illustrated in FIG. 2, in an illustrative or exemplary embodiment, a system 200 may include a CPU cluster 202, a transaction request buffer system 203, and a bus bridge system 206. System 200 may be an example of above-described system 100 (FIG. 1). Accordingly, transaction request buffer system 203 may be an example of transaction request buffer system 104 (FIG. 1) and may include a read request buffer system 204 and a write request buffer system 205. Likewise, for example, bus bridge system 206 may be an example of bus interconnect system 106 (FIG. 1). Similarly, CPU cluster 202 may be an example of processor 102 (FIG. 1). Although not shown for purposes of clarity, CPU cluster 202 may comprise one or more CPUs or CPU cores. System 200 may also include a memory subsystem 208.

In operation, CPU cluster 202 issues read and write requests to memory subsystem 208 via bus bridge system 206. Bus bridge system 206 couples or bridges the various buses utilized by CPU cluster 202, memory subsystem 208, and client components 210 and 212. Client components 210 and 212 may comprise any type of component that operates as a client of memory subsystem 208, such as, for example, a GPU, multi-media client, or other memory client. Although only two client components 210 and 212 are shown for purposes of clarity, system 200 may include any number of such client components.

Read request buffer system 204 is configured to monitor read request traffic between CPU cluster 202 and bus bridge system 206, to determine whether a read request from CPU cluster 202 to bus bridge system 206 is of a first category rather than a second category, and to buffer or store the read request if the bus transaction request is of the first category rather than the second category. Similarly, write request buffer system 205 is configured to monitor write request traffic between CPU cluster 202 and bus bridge system 206, to determine whether a write request from CPU cluster 202 to bus bridge system 206 is of the first category rather than the second category, and to buffer or store the write request if the bus transaction request is of the first category rather than the second category. As in the embodiment described above with regard to FIG. 1, the first and second categories are mutually exclusive; a read request or write request that is buffered (because it is of a type in the first category) until a condition occurs is not also immediately transferred to bus bridge system 206.

The first category may include, for example, one or more of the following types of requests: pre-fetch read requests, posted write requests, and posted L3 cache eviction requests. Thus, for example, pre-fetch read requests are buffered in read request buffer system 204, posted write requests are buffered in write request buffer system 205, etc. In an example in which pre-fetch read requests are buffered (because they are included in the first category), read requests that are not pre-fetch read requests are not buffered (because they are included in the second category). Likewise, in an example in which posted write requests are buffered (because they are included in the first category), write requests that are not posted write requests are not buffered (because they are included in the second category). In some examples, the second category may also include one or both of distributed virtual memory (“DVM”) requests and Cache Maintenance Operation (“CMO”) requests. As well understood by one of ordinary skill in the art, a “posted” request is a request for which a CPU does not wait for a response. These exemplary types of bus transaction requests that define the first category in this example are not time-critical. That is, the likelihood is low that buffering or delaying such first-category (i.e., non-time-critical) CPU requests will adversely affect overall PCD QoS. However, the likelihood may be higher that prioritizing such first-category CPU requests over requests issued by client components 210 and 212 will adversely impact overall PCD QoS. A bus transaction request's type may be identified by one or more transaction attribute bits (not shown) that CPU cluster 202 includes in the request. Transaction request buffer system 203 may read the transaction attribute bits to determine the bus transaction request type.

Bus bridge system 206 may include client read request traffic monitor 214 and client write request traffic monitor 215 configured to monitor read request traffic and write request traffic, respectively, between bus bridge system 206 and client component 210. Bus bridge system 206 may further include client read request traffic monitor 216 and client write request traffic monitor 217 configured to monitor read request traffic and write request traffic, respectively, between bus bridge system 206 and client component 212. Although in the exemplary system 200 only two client components 210 and 212 are shown for purposes of clarity, there may be any number of such client components. Regardless of the number of such client components, each may be monitored by an associated read request traffic monitor and an associated write request traffic monitor. Nevertheless, in other embodiments such client read and write request traffic monitors may be distributed or, conversely, integrated together, in any other manner.

Bus bridge system 206 may further include a buffer flush controller 218 coupled to client read request traffic monitor 214, client write request traffic monitor 215, client read request traffic monitor 216, and client write request traffic monitor 217. Buffer flush controller 218 may be configured to determine an aggregate amount of read request traffic by summing the amount of read request traffic between client component 210 and bus bridge system 206, as measured by client read request traffic monitor 214, and the amount of read request traffic between client component 212 and bus bridge system 206, as measured by client read request traffic monitor 216. Similarly, buffer flush controller 218 may be configured to determine an aggregate amount of write request traffic by summing the amount of write request traffic between client component 210 and bus bridge system 206, as measured by client write request traffic monitor 215, and the amount of write request traffic between client component 212 and bus bridge system 206, as measured by client write request traffic monitor 217.

Buffer flush controller 218 may be further configured to determine whether the aggregate amount of read request traffic is lower than a read request bandwidth threshold. Buffer flush controller 218 may be configured to generate a read request buffer flush signal 220 indicating that the aggregate amount of read request traffic is lower than a read request bandwidth threshold. Read request buffer system 204 may be further configured to transfer buffered read requests to bus bridge system 206 in response to read request buffer flush signal 220. So long as the aggregate amount of read request traffic remains lower than the read request bandwidth threshold, buffer flush controller 218 may continue to assert read request buffer flush signal 220, and read request buffer system 204 may continue to transfer buffered read requests to bus bridge system 206.

Similarly, buffer flush controller 218 may be further configured to determine whether the aggregate amount of write request traffic is lower than a write request bandwidth threshold. Buffer flush controller 218 may be configured to generate a write request buffer flush signal 222 indicating that the aggregate amount of write request traffic is lower than a write request bandwidth threshold. Write request buffer system 205 may be further configured to transfer buffered write requests to bus bridge system 206 in response to write request buffer flush signal 222. So long as the aggregate amount of write request traffic remains lower than the write request bandwidth threshold, buffer flush controller 218 may continue to assert write request buffer flush signal 222, and write request buffer system 205 may continue to transfer buffered write requests to bus bridge system 206.

Alternatively, buffer flush controller 218 may be configured to determine an aggregate amount of transaction request traffic by summing the amount of read request traffic between client component 210 and bus bridge system 206, the amount of read request traffic between client component 212 and bus bridge system 206, the amount of write request traffic between client component 210 and bus bridge system 206, and the amount of write request traffic between client component 212 and bus bridge system 206. Accordingly, buffer flush controller 218 may be further configured to determine whether this aggregate amount of transaction request traffic is lower than a transaction request bandwidth threshold and to generate both the read request buffer flush signal 220 and the write request buffer flush signal 222 when the aggregate amount of transaction request traffic is lower than the transaction request bandwidth threshold.

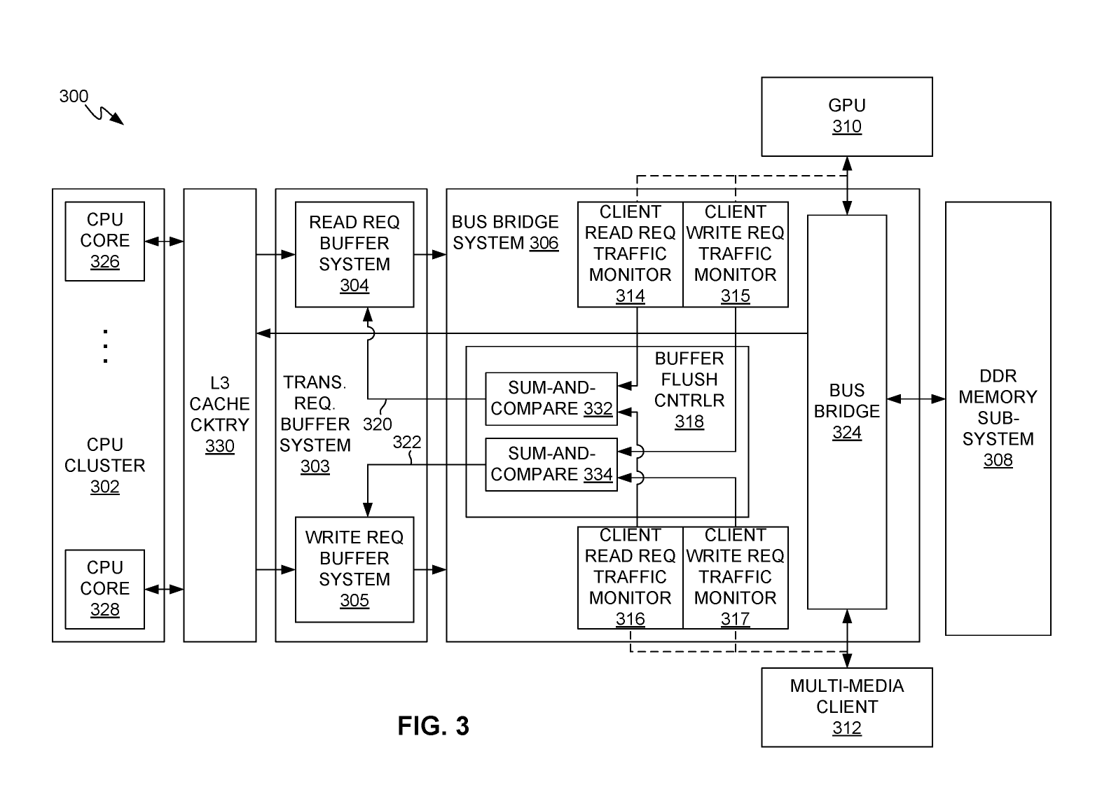

As illustrated in FIG. 3, in an illustrative or exemplary embodiment, a system 300 may include a CPU cluster 302, a transaction request buffer system 303, and a bus bridge system 306. System 300 may be an example of above-described system 200 (FIG. 2). Accordingly, transaction request buffer system 303 may be an example of transaction request buffer system 104 (FIG. 1) and may include a read request buffer system 304 and a write request buffer system 305. CPU cluster 302 may include two or more CPU cores 326, 328, etc. (where other such CPU cores that are not shown for purposes of clarity are indicated by the ellipsis (“ . . . ”) symbol). Additional circuitry may be interposed in the data communication paths between CPU cluster 302 and bus bridge system 306, such as, for example, L3 cache circuitry 330. L3 cache circuitry 330 may include conventional L3 cache control and cache coherency logic, read and write request arbitration logic, and other conventional logic of types commonly associated with L3 cache memory shared among multiple CPU cores. It should be understood that L3 cache circuitry 330 relates to such shared L3 cache memory and is distinct from, and has a different function from, read request buffer system 304 and write request buffer system 305. System 200 may also include a DDR memory subsystem 308.

In operation, any of CPU cores 326, 328, etc., may issue read and write requests to DDR memory subsystem 308 via bus bridge system 306. L3 cache circuitry 330 controls caching, arbitration, and other conventional cache-related functions associated with the read and write requests. Examples of client components that may similarly issue read and write requests to DDR memory subsystem 308 include a GPU 310 and a multi-media client 312, such as a video camera system, video player application, etc. As in the embodiments described above with regard to FIGS. 1 and 2, in this embodiment bus bridge system 306 similarly couples or bridges the various buses utilized by CPU cluster 302, DDR memory subsystem 308, GPU 310, multi-media client 312, and any other client components (not shown for purposes of clarity). Bus bridge system 306 may include a multi-master bus bridge 324 that couples or bridges such buses.

Read request buffer system 304 is configured to monitor read request traffic between CPU cluster 302 and bus bridge system 306, to determine whether a read request from CPU cluster 302 to bus bridge system 306 is of a first category rather than a second category, and to buffer or store the read request if the bus transaction request is of the first category rather than the second category. Similarly, write request buffer system 305 is configured to monitor write request traffic between CPU cluster 302 and bus bridge system 306, to determine whether a write request from CPU cluster 302 to bus bridge system 306 is of the first category rather than the second category, and to buffer or store the write request if the bus transaction request is of the first category rather than the second category. As in the embodiments described above with regard to FIGS. 1 and 2, the first and second categories are mutually exclusive; a read request or write request that is buffered (because it is of a type in the first category) until a condition occurs is not also immediately transferred to bus bridge system 306. The first and second categories on which the operation of read request buffer system 304 and write request buffer system 305 is based may be the same as described above with regard to FIG. 2.

Bus bridge system 306 may include client read request traffic monitor 314 and client write request traffic monitor 315 configured to monitor read request traffic and write request traffic, respectively, between bus bridge system 306 and GPU 310. Bus bridge system 306 may further include client read request traffic monitor 316 and client write request traffic monitor 317 configured to monitor read request traffic and write request traffic, respectively, between bus bridge system 206 and multi-media client 312. Although in the exemplary system 300 only GPU 310 and multi-media client 312 are shown for purposes of clarity, there may be any number of such client components, and each client or group of two or more similar clients (e.g., multi-media clients) may be monitored by an associated read request traffic monitor and an associated write request traffic monitor. Note that transaction request monitoring paths between bus bridge system 306 and client components such as GPU 310 and multi-media client 312 are indicated in broken line for purposes of clarity. Bus bridge 324 handles the transaction requests from GPU 310 and multi-media client 312 as well as from CPU cluster 302. Bus bridge 324 communicates the read and write requests and associated read and write data with DDR memory subsystem 308.

Bus bridge system 306 may further include a buffer flush controller 318 coupled to client read request traffic monitor 314, client write request traffic monitor 315, client read request traffic monitor 316, and client write request traffic monitor 317. Buffer flush controller 318 may include a read traffic add-and-compare circuit 332 and a write traffic add-and-compare circuit 334. Read traffic add-and-compare circuit 332 may be configured to determine an aggregate amount of read request traffic by summing the amount of read request traffic between GPU 310 and bus bridge system 306, as measured by client read request traffic monitor 314, and the amount of read request traffic between multi-media client 312 and bus bridge system 306, as measured by client read request traffic monitor 316. Similarly, write traffic add-and-compare circuit 334 may be configured to determine an aggregate amount of write request traffic by summing the amount of write request traffic between GPU 310 and bus bridge system 306, as measured by client write request traffic monitor 315, and the amount of write request traffic between multi-media client 312 and bus bridge system 206, as measured by client write request traffic monitor 317.

Read traffic add-and-compare circuit 332 may be further configured to determine whether the aggregate amount of read request traffic is lower than a read request bandwidth threshold. Read traffic add-and-compare circuit 332 may be configured to generate a read request buffer flush signal 320 indicating that the aggregate amount of read request traffic is lower than a read request bandwidth threshold. Read request buffer system 304 may be further configured to transfer buffered read requests to bus bridge system 306 (or the multi-master bus bridge 324 thereof) in response to read request buffer flush signal 320. So long as the aggregate amount of read request traffic remains lower than the read request bandwidth threshold, read traffic add-and-compare circuit 332 may continue to assert read request buffer flush signal 320, and read request buffer system 304 may continue to transfer buffered read requests to bus bridge system 306.

Similarly, write traffic add-and-compare circuit 334 may be further configured to determine whether the aggregate amount of write request traffic is lower than a write request bandwidth threshold. Write traffic add-and-compare circuit 334 may be configured to generate a write request buffer flush signal 322 indicating that the aggregate amount of write request traffic is lower than a write request bandwidth threshold. Write request buffer system 305 may be further configured to transfer buffered write requests to bus bridge system 306 (or the multi-master bus bridge 324 thereof) in response to write request buffer flush signal 322. So long as the aggregate amount of write request traffic remains lower than the write request bandwidth threshold, write traffic add-and-compare circuit 334 may continue to assert write request buffer flush signal 322, and write request buffer system 305 may continue to transfer buffered write requests to bus bridge system 306.

Read request buffer system 304 may further be configured to determine whether it is full (i.e., it has stored a threshold amount of read requests) and to transfer buffered read requests to bus bridge system 306 if read request buffer system 304 is full. Similarly, write request buffer system 305 may further be configured to determine whether it is full (i.e., it has stored a threshold amount of write requests) and to transfer buffered write requests to bus bridge system 306 if write request buffer system 305 is full.

Read request buffer system 304 may still further be configured to determine whether CPU cluster 302 has issued a read barrier transaction request and to transfer buffered read requests to bus bridge system 306 if CPU cluster 302 has issued a read barrier transaction request. Similarly, write request buffer system 305 may still further be configured to determine whether CPU cluster 302 has issued a write barrier transaction request and to transfer buffered write requests to bus bridge system 306 if CPU cluster 302 has issued a write barrier transaction request. As well understood by one of ordinary skill in the art, a barrier transaction is a request that controls the order in which previous transaction requests are acted upon. Such a barrier transaction request may be issued on a read or write channel in a system that supports separate read and write channels, or on a single read/write channel in a system that supports a single channel.

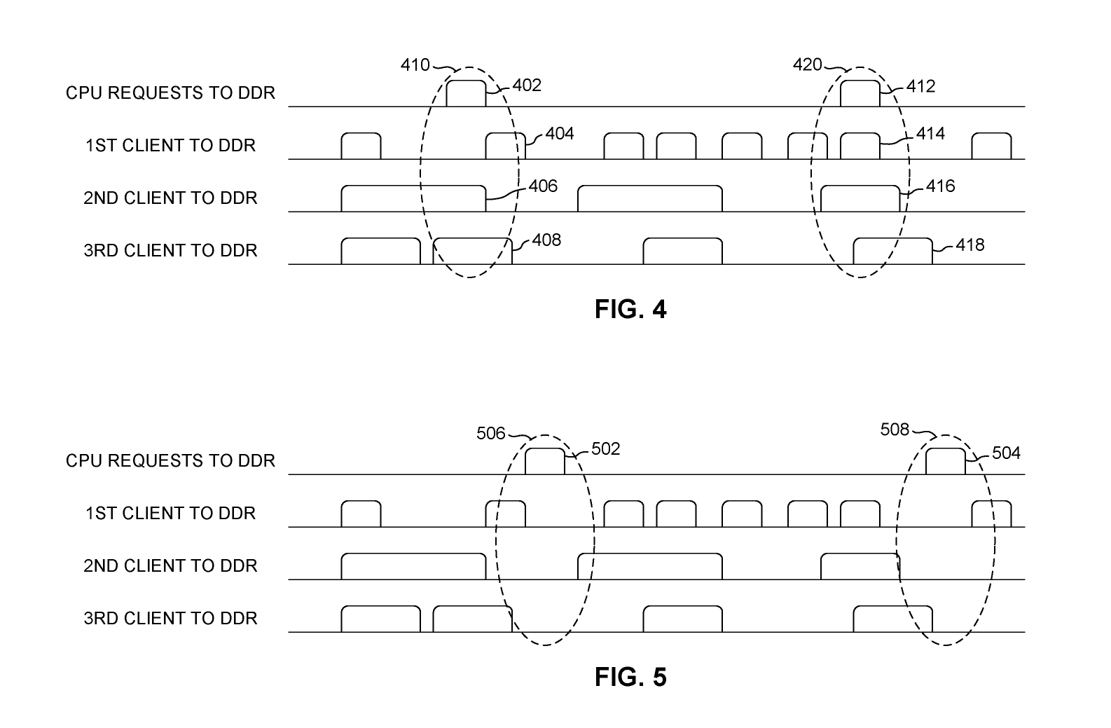

As illustrated in FIG. 4, when bus transaction requests are not buffered in the manner described above (e.g., the category-based buffering feature is bypassed or disabled), an exemplary block 402 of one or more transaction requests issued by CPU cluster 302 to DDR memory subsystem 308 or other subsystem may arrive at the subsystem contemporaneously with exemplary blocks 404, 406, 408, etc., of one or more transaction requests issued by first, second, third, etc., client components, respectively, to DDR memory subsystem 308. The contemporaneous arrival of such transaction requests at an approximate time window 410 defines a relatively high amount of bus transaction request traffic or bandwidth usage by bus bridge 324. Similarly, an exemplary block 412 of one or more bus transaction requests issued by CPU cluster 302 to DDR memory subsystem 308 or other subsystem may arrive at the subsystem contemporaneously with exemplary blocks 414, 416, 418, etc., of one or more transaction requests issued by the first, second, third, etc., client components, respectively, to DDR memory subsystem 308. The contemporaneous arrival of such bus transaction requests at an approximate time window 420 defines a relatively high amount of bus transaction request traffic or bandwidth usage by bus bridge 324. In other words, approximate time windows 410 and 420 indicate bus transaction request congestion at bus bridge 324. Although exemplary blocks 402 and 412 may comprise non-time-critical transaction (i.e., first-category) requests, they nonetheless contribute to the congestion and may also displace more time-sensitive requests from client components, since CPU requests are conventionally given blanket high priority. Servicing such non-time-critical transaction requests may delay servicing transaction requests from the other client components and thereby adversely impact QoS.

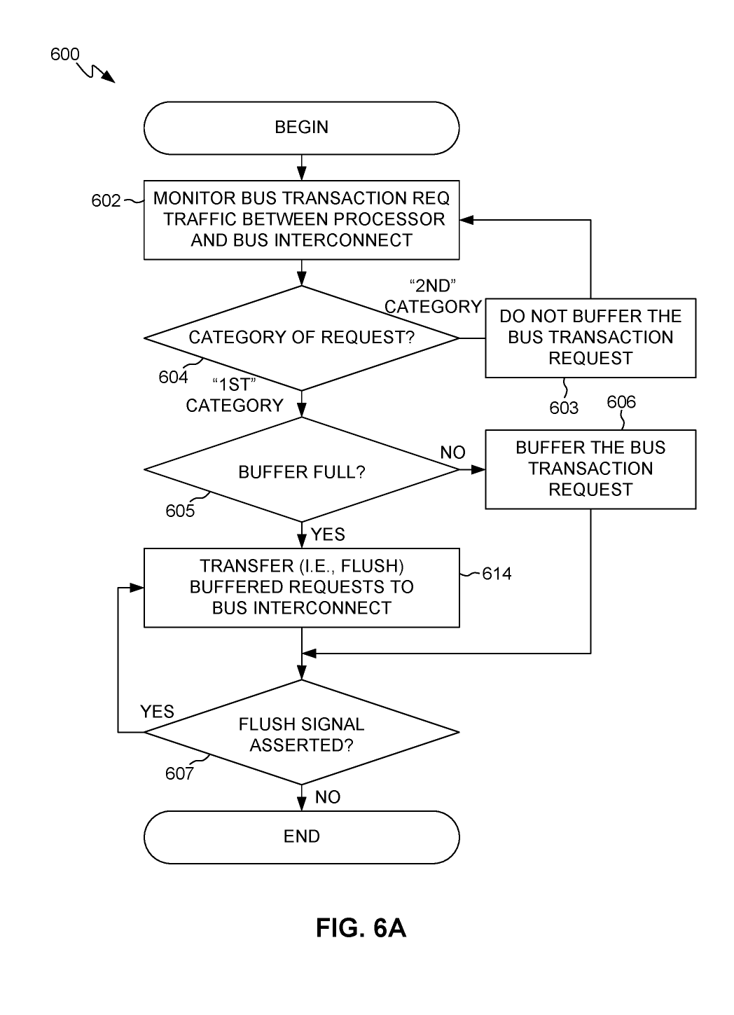

As illustrated in FIG. 5, when bus transaction requests are buffered in the manner described in this disclosure, exemplary blocks 502 and 504 of one or more bus transaction requests issued by CPU cluster 302 to DDR memory subsystem 308 or other subsystem may arrive at the subsystem during approximate time windows 506 and 508, respectively, which define relatively low amounts of bus transaction request traffic or bandwidth usage by bus bridge 324. Note that exemplary blocks 502 and 504 correspond to exemplary blocks 402 and 404 (FIG. 4), but blocks 502 and 504 have been buffered until time windows 506 and 508 opened.

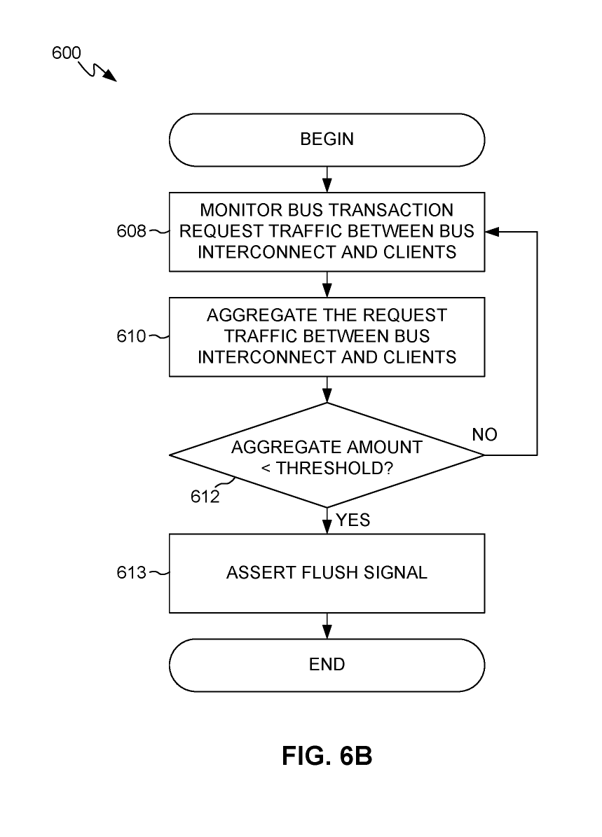

As illustrated in FIGS. 6A-6B, an exemplary method 600 for buffering bus transaction requests from a processor may describe aspects of the operation of any of the above-described exemplary systems 100, 200, or 300 or similar systems. Although certain acts or steps in method 600 naturally precede others for the exemplary embodiments to operate as described, the invention is not limited to the order of those acts or steps if such order or sequence does not alter the functionality of the invention. That is, it is recognized that some acts or steps may be performed before, after, or in parallel (i.e., substantially simultaneously) with other acts or steps without departing from the scope and spirit of the invention. In some instances, certain acts or steps may be omitted or not performed, without departing from the scope and spirit of the invention. Further, words such as “thereafter,” “then,” “next,” etc., are not intended to limit the order of the acts or steps. Rather, such words are used to aid in guiding the reader through the description of exemplary method 600.

As indicated by block 602, bus transaction request traffic between a processor and a bus interconnect system may be monitored. The bus transaction request traffic may include read requests, write requests, or other bus transaction requests to a subsystem, such as, for example, a memory subsystem, via the bus interconnect system.

As indicated by block 604, it may be determined whether a bus transaction request is of a first category or a second category. The first category may, for example, include non-time-critical requests or less-time-critical requests, i.e., types of requests that would not likely adversely impact QoS if delayed by buffering until a condition occurs, such as a less congested bandwidth window at the bus interconnect system. The second category may, for example, include certain other types of bus transactions that are not of the first category, or may consist of all bus transaction requests that are not of the first category. If it is determined (block 604) that a bus transaction request is of the second category, the bus transaction request is not buffered and thus proceeds directly to the bus interconnect system in a conventional manner, as indicated by block 603. Bus transaction request traffic between the processor and the bus interconnect system may continue to be monitored for first-category and second-category requests, as described above with regard to block 602.

If it is determined (block 604) that the bus transaction request is of the first category, then it may be determined whether the buffer is full (i.e., it has stored a threshold amount of transaction requests), as indicated by block 605. If it is determined that the buffer is full, then buffered bus transaction requests may be transferred (i.e., flushed) to the bus interconnect system, as indicated by block 614. If it is determined that the buffer is not full, then the bus transaction request is stored in the buffer, as indicated by block 606. Following the determination (block 605) of whether the buffer is full and the consequent action (block 606 or 614), it may be determined whether a flush signal is asserted, as indicated by block 607. If it is determined that the flush signal is asserted, then buffered bus transaction requests may be transferred (i.e., flushed) to the bus interconnect system, as described above with regard to block 614. So long as the flush signal remains asserted, buffered bus transaction requests may continue to be transferred to the bus interconnect system. Note that the transferring (block 614) of buffered bus transaction requests may occur concurrently with the monitoring (block 602) of bus transaction request traffic. Also note that in embodiments in which read request traffic and write request traffic are aggregated separately, buffered read requests and buffered write requests may be transferred independently, in response to independent read and write buffer flush signals.

As indicated by block 608 (FIG. 6B), bus transaction request traffic between the bus interconnect system and one or more bus client components may be monitored, i.e., measured. Bus transaction request traffic may be represented in terms of bandwidth usage, i.e., amount of data per unit time.

As indicated by block 610, the amount of bus transaction request traffic between the bus interconnect system and bus client components may be aggregated. In some embodiments, read request traffic and write request traffic may be aggregated separately. Correspondingly, in such embodiments, first-category read request traffic and first-category write request traffic may be buffered separately.

As indicated by block 612, it may be determined whether an aggregate amount of the bus transaction request traffic between the bus interconnect system and the one or more bus client components is lower than a threshold. If it is determined that the aggregate amount of the bus transaction request traffic is lower than the threshold, then the above-described flush signal may be asserted, as indicated by block 613. In embodiments in which read request traffic and write request traffic are aggregated separately, it may be determined whether the aggregate amount of read request traffic is lower than a read request traffic threshold and separately determined whether the aggregate amount of write request traffic is lower than a write request traffic threshold, and corresponding read and write request buffer flush signals may be asserted separately or independently. If it is determined (block 612) that the aggregate amount of the bus transaction request traffic between the bus interconnect system and the one or more bus client components is not lower than the threshold, then the method may continue as described above with regard to block 602 (FIG. 6A) and block 608 (FIG. 6B). Note that the steps described above with regard to FIG. 6A may occur in parallel or substantially concurrently with the steps described above with regard to FIG. 6B.

Exemplary method 600 and similar methods in accordance with the present disclosure may be controlled by one or more processors. For example, bus interconnect system 106 (FIG. 1) or bus bridge system 206 (FIG. 2) or 306 (FIG. 3) may include or be associated with one or more processors that execute logic to configure the bus interconnect system to control the method. The processor-executable logic may be embodied in at least one memory or other non-transitory storage medium. The combination of such logic and the memory in which the logic is stored or otherwise resides in non-transitory, computer-executable form, comprises a “computer program product” or portion thereof, as that term is understood in the patent lexicon.

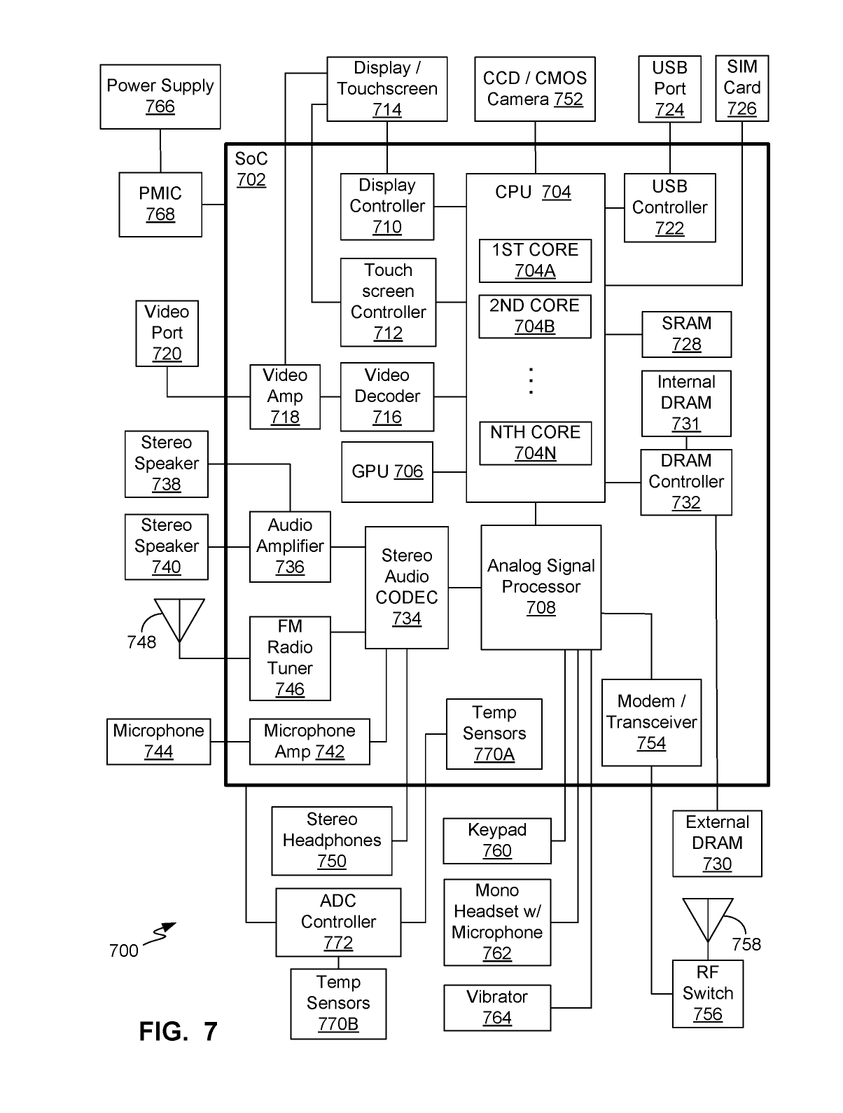

As illustrated in FIG. 7, in illustrative or exemplary embodiments, systems, methods, and computer program products for buffering bus transaction requests from a processor may be embodied in a PCD 700. PCD 700 includes a system on chip (“SoC”) 702, i.e., a system embodied in an integrated circuit chip. SoC 702 may include a central processing unit (“CPU”) 704, a graphics processing unit (“GPU”) 706, or other processors. CPU 704 may include multiple cores, such as a first core 704A, a second core 704B, etc., through an Nth core 704N. SoC 702 may include an analog signal processor 708. CPU 704 may be an example of processor 102 (FIG. 1), CPU cluster 202 (FIG. 2), or CPU cluster 302 (FIG. 3).

A display controller 710 and a touchscreen controller 712 may be coupled to CPU 704. A touchscreen display 714 external to SoC 702 may be coupled to display controller 710 and touchscreen controller 712. PCD 700 may further include a video decoder 716. Video decoder 716 is coupled to CPU 704. A video amplifier 718 may be coupled to video decoder 716 and touchscreen display 714. A video port 720 may be coupled to video amplifier 718. A universal serial bus (“USB”) controller 722 may also be coupled to CPU 704, and a USB port 724 may be coupled to USB controller 722. A subscriber identity module (“SIM”) card 726 may also be coupled to CPU 704.

One or more memories may be coupled to CPU 704. The one or more memories may include both volatile and non-volatile memories. Examples of volatile memories include static random access memory (“SRAM”) 728 and dynamic RAMs (“DRAM”s) 730 and 731. Such memories may be external to SoC 702, such as DRAM 730, or internal to SoC 702, such as DRAM 731. A DRAM controller 732 coupled to CPU 704 may control the writing of data to, and reading of data from, DRAMs 730 and 731. In other embodiments, such a DRAM controller may be included within a processor, such as CPU 704. DRAM 730 and DRAM 731 and associated elements (e.g., DRAM controller 732) may be examples of subsystem 108 (FIG. 1), memory subsystem 208 (FIG. 2), or DDR memory subsystem 308 (FIG. 3). Interconnect structures such as buses, bus bridges, interconnect fabrics, etc., of the types described above with regard to FIGS. 1-3 are not shown in FIG. 7 for purposes of clarity. In a computer program product embodiment, CPU 704 may execute logic to configure such an interconnect structure to control method 600 or other methods in accordance with the present disclosure. Such processor-executable logic may be stored in SRAM 728, for example.

A stereo audio CODEC 734 may be coupled to analog signal processor 708. Further, an audio amplifier 736 may be coupled to stereo audio CODEC 734. First and second stereo speakers 738 and 740, respectively, may be coupled to audio amplifier 736. In addition, a microphone amplifier 742 may be also coupled to stereo audio CODEC 734, and a microphone 744 may be coupled to microphone amplifier 742. A frequency modulation (“FM”) radio tuner 746 may be coupled to stereo audio CODEC 734. An FM antenna 748 may be coupled to the FM radio tuner 746. Further, stereo headphones 750 may be coupled to stereo audio CODEC 734. Other devices that may be coupled to CPU 704 include a digital (e.g., CCD or CMOS) camera 752.

A modem or radio frequency (“RF”) transceiver 754 may be coupled to analog signal processor 708. An RF switch 756 may be coupled to RF transceiver 754 and an RF antenna 758. In addition, a keypad 760, a mono headset with a microphone 762, and a vibrator device 764 may be coupled to analog signal processor 708.

A power supply 766 may be coupled to SoC 702 via a power management integrated circuit (“PMIC”) 768. Power supply 766 may include a rechargeable battery or a DC power supply that is derived from an AC-to-DC transformer connected to an AC power source.

The SoC 702 may have one or more internal or on-chip thermal sensors 770A and may be coupled to one or more external or off-chip thermal sensors 770B. An analog-to-digital converter (“ADC”) controller 772 may convert voltage drops produced by thermal sensors 770A and 770B to digital signals.

The touch screen display 714, the video port 720, the USB port 724, the camera 752, the first stereo speaker 738, the second stereo speaker 740, the microphone 744, the FM antenna 748, the stereo headphones 750, the RF switch 756, the RF antenna 758, the keypad 760, the mono headset 762, the vibrator 764, the thermal sensors 770B, the PMIC 768, the power supply 766, the DRAM 730, and the SIM card 726 are external to the SoC 702 in this exemplary or illustrative embodiment. It will be understood, however, that in other embodiments one or more of these devices may be included in such an SoC.

Alternative embodiments will become apparent to one of ordinary skill in the art to which the invention pertains without departing from its spirit and scope. For example, although not shown, a similar method for buffering transaction requests can be implemented between different levels of cache, such as between L1 and L2, between L2 and L3, and between shared and private cache hierarchies. Therefore, although selected aspects have been illustrated and described in detail, it will be understood that various substitutions and alterations may be made therein without departing from the spirit and scope of the present invention, as defined by the following claims.

1. A method for buffering bus transaction requests from a processor, comprising:
monitoring bus transaction request traffic between a processor and a bus interconnect system;
determining whether a bus transaction request from the processor to the bus interconnect system is of a first category;
buffering the bus transaction request in a buffer to defer transferring the bus transaction request to the bus interconnect system in response to determining at least that the bus transaction request is of the first category.

2. The method of claim 1, wherein:
monitoring bus transaction request traffic comprises reading one or more attribute bits of the bus transaction request; and
determining whether the bus transaction request from the processor to the bus interconnect system is of the first category is based on the one or more attribute bits.

3. The method of claim 1, further comprising:
determining whether the buffer is full; and
transferring buffered bus transaction requests to the bus interconnect system in response to determining the buffer is full.

4. The method of claim 1, further comprising:
monitoring for a window in bus transaction request traffic between the bus interconnect system and one or more bus client components; and
transferring buffered bus transaction requests to the bus interconnect system when a window in bus transaction request traffic occurs.

5. The method of claim 4, wherein monitoring for a window in bus transaction request traffic comprises determining whether an aggregate amount of the bus transaction request traffic between the bus interconnect system and the one or more bus client components is lower than a threshold.

6. The method of claim 5, wherein:
the bus transaction request traffic between the processor and the bus interconnect system comprises read requests and write requests to a memory subsystem coupled to the bus interconnect system; and
the bus transaction request traffic between the bus interconnect system and the one or more bus client components comprises read requests and write requests to the memory subsystem coupled to the bus interconnect system.

7. The method of claim 6, wherein:
determining whether an aggregate amount of the bus transaction request traffic between the bus interconnect system and the one or more bus client components is lower than a threshold comprises determining an aggregate amount of read request traffic and determining an aggregate amount of write request traffic;
transferring buffered bus transaction requests to the bus interconnect system comprises transferring buffered read requests in response to determining the aggregate amount of read request traffic between the bus interconnect system and the one or more bus client components is lower than a read request traffic threshold; and
transferring buffered bus transaction requests to the bus interconnect system further comprises transferring buffered write requests in response to determining the aggregate amount of write request traffic between the bus interconnect system and the one or more bus client components is lower than a write request traffic threshold.

8. The method of claim 1, wherein the first category includes pre-fetch read requests, posted write requests, and posted cache eviction requests.

9. The method of claim 1, further comprising determining whether a bus transaction request from the processor to the bus interconnect system is of a second category, the second category including non-prefetch read requests, distributed virtual memory (“DVM”) requests, and Cache Maintenance Operation (“CMO”) requests, wherein the first category does not include non-prefetch read requests, DVM requests, and CMO requests, and wherein bus transaction requests determined to be of the second category are transferred directly to the bus interconnect system without buffering.

10. The method of claim 1, wherein the processor and the bus interconnect system are included in a system-on-chip (“SoC”).

11. A system for buffering bus transaction requests from a processor, the system comprising:
a bus interconnect system configured to interconnect a processor bus and a subsystem bus;
a buffer memory system configured to monitor bus transaction request traffic between a processor and the bus interconnect system, to determine whether a bus transaction request from the processor to the bus interconnect system is of a first category, and to buffer the bus transaction request in a buffer to defer transferring the bus transaction request to the bus interconnect system in response to determining at least that the bus transaction request is of the first category.

12. The system of claim 11, wherein the buffer memory system is configured to determine whether a bus transaction request from the processor to the bus interconnect system is of a first category by reading one or more attribute bits of the bus transaction request.

13. The system of claim 11, further comprising a buffer flush controller coupled to the buffer memory system, the buffer flush controller configured to determine whether the buffer is full and to initiate transfer of buffered bus transaction requests to the bus interconnect system in response to determining the buffer is full.

14. The system of claim 11, further comprising:
a buffer flush controller coupled to the buffer memory system; and
a client bus transaction request traffic monitor configured to monitor bus transaction request traffic between the bus interconnect system and one or more bus client components, wherein the buffer flush controller is configured to monitor for a window in bus transaction request traffic between the bus interconnect system and one or more bus client components and to initiate transfer of buffered bus transaction requests to the bus interconnect system when a window in bus transaction request traffic occurs.

15. The system of claim 14, wherein the client bus transaction request traffic monitor is configured to monitor for a window in bus transaction request traffic by determining whether an aggregate amount of the bus transaction request traffic between the bus interconnect system and the one or more bus client components is lower than a threshold.

16. The system of claim 15, wherein:
the bus transaction request traffic between the processor and the bus interconnect system comprises read requests and write requests to a memory subsystem coupled to the bus interconnect system; and
the bus transaction request traffic between the bus interconnect system and the one or more bus client components comprises read requests and write requests to the memory subsystem coupled to the bus interconnect system.

17. The system of claim 16, wherein:
the client bus transaction request traffic monitor is configured to determine whether an aggregate amount of the bus transaction request traffic between the bus interconnect system and the one or more bus client components is lower than a threshold by determining an aggregate amount of read request traffic and determining an aggregate amount of write request traffic;
the buffer flush controller is configured to initiate transfer of buffered read requests to the bus interconnect system when the aggregate amount of read request traffic between the bus interconnect system and the one or more bus client components is lower than a read request traffic threshold; and
the buffer flush controller is configured to initiate transfer of buffered write requests to the bus interconnect system when the aggregate amount of write request traffic between the bus interconnect system and the one or more bus client components is lower than a write request traffic threshold.

18. The system of claim 11, wherein the first category includes pre-fetch read requests, posted write requests, and posted cache eviction requests.

19. The system of claim 11, wherein the buffer memory system is further configured to determine whether the bus transaction request from the processor to the bus interconnect system is of a second category, the second category including non-prefetch read requests, distributed virtual memory (“DVM”) requests, and Cache Maintenance Operation (“CMO”) requests, wherein the first category does not include non-prefetch read requests, DVM requests, and CMO requests, and wherein bus transaction requests determined to be of the second category are transferred directly to the bus interconnect system without buffering.

20. The system of claim 11, wherein the processor and the bus interconnect system are included in a system-on-chip (“SoC”).

21-30. (canceled)
